(19) United States
(12) Patent Application Publication
(10) Pub. No.: US 2023/0415188 A1
(43) Pub. Date: Dec. 28, 2023

(54) RETRACTABLE CLEANING APPARATUS AND SYSTEM

(71) Applicant: ALFA LAVAL CORPORATE AB, Lund (SE)

(72) Inventor: Bo Boye Busk JENSEN, Rödovre (DK)

(73) Assignee: ALFA LAVAL CORPORATE AB, Lund (SE)

(21) Appl. No.: 18/253,410

(22) PCT Filed: Nov. 29, 2021
(86) PCT No.: PCT/EP2021/083367

§ 371 Date: May 18, 2023

(30) Foreign Application Priority Data
Nov. 30, 2020 (EP) 20210720.7

(51) Int. Cl. B05B 13/06; B05B 1/20; B05B 13/04; B05B 15/72

(52) U.S. Cl. CPC B05B 13/0636; B05B 1/20; B05B 13/0405; B05B 15/72

(57) ABSTRACT

A retractable cleaning apparatus for spray cleaning of pipes or vessels comprises a rotatable spray head configured to spray the interior of the pipes or vessels with a cleaning liquid. The rotatable spray head is linearly movable between a retracted position and a cleaning position along a longitudinal axis of the rotatable spray head. The rotatable spray head is rotatable about the longitudinal axis of the rotatable spray head independent of a flow of the cleaning liquid. The rotatable spray head is rotatable with an angular velocity that is independent of the flow of the cleaning liquid. The angular velocity may be within a range of 0.1-1.3 radians per second. A system including a retractable cleaning apparatus is also disclosed.

### TECHNICAL FIELD

The present invention relates to a retractable cleaning apparatus for spray cleaning of pipes or vessels, and in particular to a retractable cleaning apparatus having a rotatable spray head configured to spray the interior of the pipes or vessels with a cleaning liquid. A system including a retractable cleaning apparatus is also disclosed.

### BACKGROUND ART

Ducts and tanks for various liquids or gases are used in a number of industrial processes such as spray drying plants, food manufacturing, pharmaceutical manufacturing, chemical processing, material fermentation and so on. It is often critical to ensure that the interior of the ducts and tanks are free of unwanted debris and contaminants.

Unwanted contaminants in such ducts and tanks may negatively influence the quality of the finished product being manufactured, processed or stored. Also, the interior of a duct or a tank must be properly cleaned if regulations applying to certain industries such as food and pharmaceutical industries shall be followed. Thus, it is common to clean the interior of such ducts and tanks at certain intervals, e.g. after each process batch, to ensure product quality and adherence to any relevant regulations.

Spray cleaning systems are available that clean debris and residue from the interior of ducts, tanks and other vessels through the use of what is commonly known as spray cleaning or impingement cleaning.

One common type of such spray cleaning systems employs a retractable cleaning apparatus that is attached to and insertable into the duct or tank to be cleaned. Such cleaning apparatuses typically exhibits a rotatable spray part or body which is insertable into the duct or tank upon cleaning. When not used, the spray part or body is typically retracted form the duct or tank, leaving the duct or tank substantially unaffected. The rotatable spray part of such apparatuses typically rotates during cleaning of the duct or tank such that an ejected liquid is sprayed and impinges on surfaces of the duct or tank to be cleaned. Moreover, such apparatuses are typically placed at regular intervals in ducts in order to accomplish a satisfactory coverage of the interior of the ducts. The liquid being sprayed from the rotatable spray part is typically driving the rotation of the spray part due to reactional forces exhibited on the rotatable spray part by the liquid leaving the same under pressure. This type of rotatable spray parts, commonly referred to as free spinning, typically rotates about 100 rpm, but the actual rotation speed is influenced by e.g. the liquid pressure, the amount of liquid being sprayed and design of the rotatable spray part to give a few examples. As a consequence, each cleaning apparatus has a certain spray length for which spray length efficient cleaning is accomplished, i.e. for which length a sufficient spray pattern and pressure is achieved. This means that for longer pipes and large tanks a plurality of cleaning apparatuses must be installed at regular intervals.

A cleaning apparatus of the above described kind is disclosed in DE 20 2004 012 949 U1. DE 20 2004 012 949 U1 discloses an apparatus for internal cleaning of tanks. The apparatus includes a spray body or part which is insertable into the tank to be cleaned. The spray body is rotated by means of liquid being ejected through a plurality of spray nozzles provided at the spray body.

Present techniques provide solutions for cleaning of the interior of ducts and tanks. However, in some cases the efficiency of the cleaning apparatuses has proven to be non-satisfactory. Moreover, the spray length of the apparatuses is hard to predict since the spray length will be influenced by the actual liquid pressure and the resulting rotation speed as well as the design of the rotatable spray part. Furthermore, the higher the rotation speed gets, the shorter the spray length gets. This results in that cleaning apparatuses must be installed at relatively short distances from each other to ensure that sufficient cleaning is provided. This in turn results in high consumption of liquid which is undesirable. Further, installation of many cleaning apparatuses results in an increased cost and an increased workload for both installation and maintenance. Furthermore, the more cleaning apparatuses that are used in a system, the greater the risk get for malfunctions and downtime. Another drawback with an increased number of cleaning apparatuses is that the risk of leakages increases since more sealing surface are introduced in the ducts or tanks of the system at hand.

Hence, there is a need for an improved retractable cleaning apparatus.

### SUMMARY

In view of the above, it is an object of the present invention is to provide an improved retractable cleaning apparatus for spray cleaning of pipes or vessels.

Another object is to provide such a retractable cleaning apparatus which is capable of an improved spray length.

Another object is to provide such a retractable cleaning apparatus which requires fewer cleaning apparatuses to be installed in a system.

Another object is to provide such a retractable cleaning apparatus which is capable of reducing the amount of liquid or cleaning liquid used for cleaning.

Another object is to provide such a retractable cleaning apparatus in which a spray pattern of a cleaning liquid may be controlled.

It is also an object to provide a cost-effective retractable cleaning apparatus.

To achieve at least one of the above objects and also other objects that will be evident from the following description, a retractable cleaning apparatus having the features defined in claim 1 is provided according to the present inventive concept. A corresponding system having the features defined in claim 18 is provided according to the present inventive concept. Preferred variations to the inventive concept will be evident from the dependent claims.

More specifically, according to a first aspect, there is provided a retractable cleaning apparatus for spray cleaning of pipes or vessels, the retractable cleaning apparatus comprising: a rotatable spray head configured to spray the interior of the pipes or vessels with a cleaning liquid, wherein the rotatable spray head being linearly movable between a retracted position and a cleaning position along a longitudinal axis of the rotatable spray head, wherein the rotatable spray head being rotatable about the longitudinal axis of the rotatable spray head independent of a flow of the cleaning liquid, and wherein the rotatable spray head being rotatable with an angular velocity that is independent of the flow of the cleaning liquid.

Hereby an improved retractable cleaning apparatus for spray cleaning of pipes or vessels is provided. The retractable cleaning apparatus is advantageous in that it includes a rotatable spray head which provides efficient cleaning of the interior of the pipes or vessels to be cleaned by spraying the interior of the pipes or vessels with a cleaning liquid while the spray head is rotated about the longitudinal axis thereof independent of a flow of the cleaning liquid. By this arrangement, the spray head may be rotated with an angular velocity that is independent of the flow of the cleaning liquid. This enables rotation with a low angular velocity. The angular velocity can be low even if the flow of the cleaning liquid is high. The angular velocity can be low also if the flow of the cleaning liquid is preserved or increased. A relatively speaking low rotation speed brings about that the cleaning liquid being sprayed from the rotatable spray head has a limited tangential velocity component. The limited tangential velocity component efficiently contributes to an increased spray length since a major part or substantial part of the velocity the cleaning liquid is given when leaving rotatable spray head is in a radial direction of the rotatable spray head, hence contributing to the spray length. The increased spray length results in that fewer retractable cleaning apparatuses may be installed for a certain pipe length or vessel size since each retractable cleaning apparatus may efficiently clean the pipe or vessel at hand at an increased distance from the retractable cleaning apparatus. At the same time, the amount of cleaning liquid required may be reduced since a reduced number of retractable cleaning apparatuses are required. The use of a limited amount of cleaning liquid brings about that a less liquid- and energy-consuming cleaning may be performed. The retractable cleaning apparatus thus becomes more economical.

Moreover, since the rotatable spray head is rotatable about the longitudinal axis of the rotatable spray head independent of a flow of the cleaning liquid, the retractable cleaning apparatus may efficiently be used to blow air into the pipes or vessels at hand. Blowing of air into the pipes or vessels may allow for an efficient emptying or drying of the pipes or vessels. Blowing of air can be performed without risk of break down due to lack of lubrication. This advantage is even more pronounced since the rotatable spray head is rotatable with an angular velocity that is independent of the flow of the cleaning liquid.

Moreover, since the rotatable spray head is rotatable about the longitudinal axis of the rotatable spray head independent of a flow of the cleaning liquid, the retractable cleaning apparatus may efficiently be used to extract air from to the pipes or vessels at hand. Extraction of air can be performed without risk of break down due to lack of lubrication. This advantage is even more pronounced since the rotatable spray head is rotatable with an angular velocity that is independent of the flow of the cleaning liquid.

The rotatable spray head is linearly movable between a retracted position and a cleaning position along a longitudinal axis of the rotatable spray head. In the retracted position, the spray head is located outside, or substantially outside, of the pipe or vessel in question. In practice, the spray head may be retracted such that an end portion or outermost portion of the spray head is visible from an inside of the pipe or vessel, while sealing the pipe or vessel. Hence, when in the retracted position, the rotatable spray head will in practice not influence the interior of the pipe or vessel in question or will only influence the interior of the pipe or vessel in question to a limited amount. On the other hand, when the rotatable spray head is in the cleaning position, the rotatable spray head is moved into the interior of the pipe or vessel in question such that the interior of the pipe or vessel in question may be cleaned by the cleaning liquid.

The wording cleaning liquid may refer to any type of liquid which is suitable for cleaning the pipes or vessels at hand. The cleaning liquid may be water. The cleaning liquid may comprise water. The cleaning liquid may comprise a detergent. The cleaning liquid may be heated or cooled.

The wording pipe may refer to any type of pipe, tube, conduit, duct or similar that may be used to convey a fluid, i.e. a gas or a liquid, or a bulk material.

The wording vessel may refer to any type of space, confined space, kettle, container, tank or similar that may be used to hold or store a fluid, i.e. a gas or a liquid, or a bulk material.

The retractable cleaning apparatus may be configured to receive cleaning liquid having a pressure in a range of 2-8 bars, which is advantageous in that efficient cleaning of the pipes or vessels at hand may be achieved.

The rotatable spray head may be rotatable with an angular velocity within a range of 0.1-1.3 radians per second. By this arrangement, the spray head may be rotated with an angular velocity within a range of 0.1-1.3 radians per second independent of the flow of the cleaning liquid. Hence, the spray head may be rotated at an instantaneous rotation speed corresponding to about 0.95-12.4 rpms. The relatively speaking low rotation speed brings about that the cleaning liquid being sprayed from the rotatable spray head has a limited tangential velocity component contributing to an increased spray length resulting that the needed number of retractable cleaning apparatuses is reduced and reduced liquid and energy consumption during cleaning as well as reduced costs as described above.

The rotatable spray head may be rotatable about the longitudinal axis of the rotatable spray head independent of the rotatable spray head being linearly movable between the retracted position and the cleaning position along the longitudinal axis of the rotatable spray head. In slightly other words, the rotation, i.e. the rotational movement, of the rotatable spray head about the longitudinal axis may be independent of the linear movement of the rotatable spray head along the longitudinal axis between the retracted position and the cleaning position. This implies that the rotational movement of the rotatable spray head is unrestrained by the linear movement. Thereby, the rotational movement of the rotatable spray head can be performed without any linear movement. This means that the rotatable spray head can be rotated without moving the rotatable spray head linearly along the longitudinal axis. Thus, the rotational movement can be performed and chosen such appropriate cleaning is achieved without being bound by any retractional movement.

The rotatable spray head may be configured for reciprocating rotation about the longitudinal axis of the rotatable spray head, which is advantageous in that a controlled rotation of the rotatable spray head may be achieved in an efficient manner. The use of a reciprocating rotation about the longitudinal axis of the rotatable spray head further allows that the cleaning may be controlled as desired. For instance, the retractable cleaning apparatus may be operated so as to achieve an improved cleaning effect in certain directions such as along a longitudinal direction of a pipe. Moreover, the retractable cleaning apparatus may be operated so as to achieve different traverse speeds of the cleaning liquid being sprayed from the rotatable spray head in certain areas of the interior of the pipes or vessels at hand.

The retractable cleaning apparatus may further comprise a pneumatically or hydraulically driven unit, wherein the pneumatically or hydraulically driven unit is configured to convert a reciprocatingly translational drive movement to a reciprocatingly rotational movement of the rotatable spray head, which is advantageous in that a controlled reciprocatingly rotational movement of the rotatable spray head may be realized from a translational drive movement. Hence, a reciprocatingly rotational movement of the rotatable spray head may be achieved from a pneumatically or hydraulically driven translational drive movement.

The rotatable spray head may be coupled to a rotatable member, and the pneumatically or hydraulically driven unit may include a linearly movable first piston, the pneumatically or hydraulically driven unit may be configured to convert a reciprocatingly translational drive movement of the linearly movable first piston to a reciprocatingly rotational movement of the rotatable member. By this arrangement, a reciprocatingly rotational movement of the rotatable member and consequently the rotatable spray head may be achieved by linearly moving the linearly movable first piston reciprocatingly. The linearly movable first piston may be moved linearly by a pressure. The pressure may for instance be exerted by pressurized air or hydraulic oil. The linearly movable first piston may be pneumatically or hydraulically driven. The first piston may be referred to as a rotation piston.

The linearly movable first piston may be arranged in a piston chamber, the piston chamber may include a first fluid port configured to pass a fluid into or out of the piston chamber on a first side of the linearly movable first piston, such that the linearly movable first piston is linearly moved in the piston chamber in response to passing fluid into or out of the piston chamber through the first fluid port, which is advantageous in that the linearly movable first piston may be moved in a controlled and simple manner. By this arrangement, the linearly movable first piston may be linearly moved in the piston chamber in response to passing fluid into or out of the piston chamber through the first fluid port. The fluid may be any suitable gas or liquid, such as air, oil or water. For example, the fluid may be pressurized air or hydraulic oil. Hence, the linearly movable first piston may be linearly moved in the piston chamber by adding or removing fluid to/from the piston chamber on a first side of the linearly movable first piston via the first fluid port.

The piston chamber may include a second fluid port configured to pass fluid into or out of the piston chamber on a second side of the linearly movable first piston, such that the linearly movable first piston is linearly moved in the piston chamber in response to passing fluid into or out of the piston chamber through the second fluid port, which is advantageous in that the linearly movable first piston may be moved with an improved accuracy and power.

The rotatable member may be mechanically coupled to the linearly movable first piston, which is advantageous in that a linear movement of the movable first piston may result in a rotational movement of the rotatable member and consequently the rotatable spray head.

The rotatable member may be mechanically coupled to the linearly movable first piston by means of a cam arrangement or by means of threads, which is advantageous in that a linear movement of the movable first piston may result in a rotational movement of the rotatable member and consequently the rotatable spray head. By this arrangement a reliable and robust coupling which may convert a linear movement to a rotational movement may be achieved.

The cam arrangement may include a helical cam groove used in combination with a cam protrusion. The cam protrusion may be configured to follow the cam groove. The rotatable member may include a cam protrusion and the linearly movable first piston a cam groove. The rotatable member may include a cam groove and the linearly movable first piston a cam protrusion.

The cam arrangement may include a plurality of helical cam grooves used in combination with a plurality of corresponding cam protrusions. The cam protrusions may be configured to follow the cam grooves. The rotatable member may include a plurality of cam protrusions and the linearly movable first piston a plurality of cam grooves. The rotatable member may include a plurality of cam grooves and the linearly movable first piston a plurality of cam protrusions.

The threads may include a single outer thread and a corresponding inner thread. The threads may include a plurality of outer threads and corresponding inner threads. The rotatable member may include inner threads and the linearly movable first piston outer threads. The rotatable member may include outer threads and the linearly movable first piston inner threads.

The retractable cleaning apparatus may further comprise a pneumatically or hydraulically driven linearly movable second piston mechanically coupled to the rotatable spray head, the linearly movable second piston may be configured to linearly move the rotatable spray head between the retracted position and the cleaning position, which is advantageous in that the rotatable spray head may be moved between the retracted position and the cleaning position in an efficient and controlled manner. The linearly movable second piston may be arranged in a piston chamber. The second piston may be referred to as a retraction piston.

The linearly movable second piston may move the rotatable spray head corresponding to a movement of the linearly movable second piston. The linearly movable second piston may move further components of the retractable cleaning apparatus with respect to the pipes or vessels. The linearly movable second piston may move more or less the complete retractable cleaning apparatus with respect to the pipes or vessels.

The piston chamber used for the linearly movable second piston may include a third fluid port configured to pass a fluid into or out of the piston chamber on a first side of the linearly movable second piston, such that the linearly movable second piston is linearly moved in the piston chamber in response to passing fluid into or out of the piston chamber through the third fluid port, which is advantageous in that the linearly movable second piston and the rotatable spray head may be moved in a controlled and simple manner. By this arrangement, the linearly movable second piston may be linearly moved in the piston chamber in response to passing fluid into or out of the piston chamber through the third fluid port. The fluid may be any suitable gas or liquid, such as air, oil or water. For example, the fluid may be pressurized air or hydraulic oil. Hence, the linearly movable second piston may be linearly moved in the piston chamber by adding or removing fluid to/from the piston chamber on a first side of the linearly movable first piston via the third fluid port, such that the rotatable spray head is moved correspondingly.

The linearly movable second piston and the rotatable spray head may be moved in one direction by means of a spring. The spring may be arranged to push the linearly movable second piston back when evacuating or draining air form the piston chamber used for the linearly movable second piston through the third fluid port, which is advantageous in that the rotatable spray head may be retracted in the event of a pressure loss.

The piston chamber used for the linearly movable second piston may include a fourth fluid port configured to pass fluid into or out of the piston chamber on a second side of the linearly movable second piston, such that the linearly movable second piston is linearly moved in the piston chamber in response to passing fluid into or out of the piston chamber through the fourth fluid port, which is advantageous in that the linearly movable second piston and the rotatable spray head may be moved with an improved accuracy and power.

The pneumatically or hydraulically driven unit and the pneumatically or hydraulically driven linearly movable second piston may be provided in a common actuator. The pneumatically or hydraulically driven unit and the pneumatically or hydraulically driven linearly movable second piston may thereby be combined in a common actuator. By arranging the pneumatically or hydraulically driven unit and the pneumatically or hydraulically driven linearly movable second piston in a common actuator, the design, manufacturing and handling is enhanced. The design will also be also more compact. Further, the cleanability is improved and cleaning is simplified since only a common actuator is necessary to clean and the number of surfaces are reduced. Providing the driven unit and the second piston in a common actuator also reduces cost.

The pneumatically or hydraulically driven unit and the pneumatically or hydraulically driven linearly movable second piston may be provided in a common housing of the common actuator.

Any one or more of the rotatable member, the rotationally symmetric protrusion, the first piston, the intermediate member, the piston chamber of the first piston, the second piston, the piston chamber of the second piston, the spring of the second piston, the external threads, the internal threads, the cam arrangement, the cam groove and the cam protrusion may be provided in the actuator, preferably in the housing of the actuator. The first fluid port and/or the second fluid port may be provided in or on the actuator, preferably in or on the housing of the actuator.

Each rotational movement of the reciprocatingly rotational movement may be less than 8 radians, preferably less than 7 radians, which is advantageous in that all directions, a desired range of directions or a particular direction may be covered by each reciprocatingly rotational movement. Since 8 radians roughly correspond to 458 degrees and 7 radians roughly corresponds to 401 degrees, all directions may be covered by a single reciprocatingly rotational movement of 8 radians or 7 radians or slightly less than 7 radians.

By the wording each rotational movement of the reciprocatingly rotational movement is intended a rotational movement in one direction before the rotation direction changes, i.e. before the rotation direction is revered.

The rotatable spray head may include a plurality of nozzle channels each terminating in a nozzle orifice, a majority of the nozzle channels may extend in a radial direction of the rotatable spray head, which is advantageous in that the retractable cleaning apparatus may allow for an efficient cleaning of the pipes or vessels at hand. A plurality of nozzle channels allows for that a spray pattern including a plurality of spray jets may be achieved. The design of the nozzle channels and in particular of the nozzle orifices may be tailored to alter the properties of the individual spray jets. By the arrangement where a majority of the nozzle channels extend in a radial direction of the rotatable spray head, the spray length of the retractable cleaning apparatus may be improved since a majority or all of the nozzle channels may extend in a radial direction of the rotatable spray head. Hence, a majority or all of the nozzle channels may be directed straight outwards in any radial direction and may thus not be inclined to give a reactional drive force to the rotatable spray head.

By the wording radial direction is intended any direction coinciding with any arbitrary plane coinciding with the longitudinal axis of the rotatable spray head. In other words, any direction not providing a reactional rotational force on the rotatable spray head is intended.

The rotatable spray head may include a plurality of nozzle channels each terminating in a nozzle orifice, at least two of the nozzle channels may extend at different angles with respect to the longitudinal axis of the rotatable spray head, which is advantageous in that a spray pattern including a plurality of spray jets spraying in different directions may be achieved. By this arrangement, a spray pattern with an improved coverage may be achieved. Hence, a cleaning effect of the retractable cleaning apparatus may be improved.

The rotatable spray head may include 4-40 nozzle channels, preferably 4-30 nozzle channels, more preferred 10-30 nozzle channels, even more preferred 20-25 nozzle channels, each terminating in a nozzle orifice, which is advantageous in that an efficient cleaning may be achieved while using a limited amount of cleaning liquid. Alternatively, the rotatable spray head may include 4-20 nozzle channels, such as 10-14 nozzle channels, each terminating in a nozzle orifice.

Each nozzle orifice may have a diameter within a range of 0.5-5 mm, preferably 1-3 mm, which is advantageous in that spray jets with efficient cleaning properties and spray lengths may be achieved.

According to an alternative aspect, there is provided a retractable cleaning apparatus for spray cleaning of pipes or vessels, the retractable cleaning apparatus comprising: a rotatable spray head configured to spray the interior of the pipes or vessels with a cleaning liquid, wherein the rotatable spray head being linearly movable between a retracted position and a cleaning position along a longitudinal axis of the rotatable spray head, wherein the rotatable spray head being rotatable about the longitudinal axis of the rotatable spray head independent of a flow of the cleaning liquid, and wherein the rotatable spray head being rotatable with an angular velocity within a range of 0.1-1.3 radians per second.

Generally, the alternative aspect may incorporate any of the above features as discussed in conjunction with the retractable cleaning apparatus according the first aspect. Moreover, features of the alternative aspect generally provide similar advantages as discussed above in relation to the first aspect of the retractable cleaning apparatus.

According to a second aspect, there is provided a system. The system comprises: a pipe or a vessel, a retractable cleaning apparatus according to the above described first aspect or alternative aspect, wherein the retractable cleaning apparatus is attached to the pipe or vessel and is configured to spray an interior surface of the pipe or vessel with the cleaning liquid.

Generally, the second aspect may incorporate any of the above features as discussed in conjunction with the retractable cleaning apparatus according the first aspect. Moreover, features of the second aspect generally provide similar advantages as discussed above in relation to the first aspect of the retractable cleaning apparatus.

Further features of, and advantages with, the present inventive concept will become apparent when studying the appended claims and the following description. The skilled person will realize that different features of the present inventive concept may be combined to create variants other than those described in the following, without departing from the scope of the present inventive concept.

### BRIEF DESCRIPTION OF THE DRAWINGS

Embodiments of the inventive concept will now be described, by way of example, with reference to the accompanying schematic drawings, in which

FIG. 1a is a schematic view of a system including a retractable cleaning apparatus in a cleaning position for cleaning an interior surface of a pipe or a vessel,

FIG. 1b is a schematic view of the system of FIG. 1a wherein the retractable cleaning apparatus is in a retracted position,

FIG. 2 is a schematic cross-sectional view of the retractable cleaning apparatus of FIGS. 1a-b,

FIG. 3 is a schematic cross-sectional view of a rotatable spray head of the retractable cleaning apparatus of FIGS. 1a-b and 2, and

FIG. 4 is a schematic cross-sectional view of a pneumatically driven unit including a cam arrangement and configured to convert a reciprocatingly translational drive movement to a reciprocatingly rotational movement.

### DETAILED DESCRIPTION

The present inventive concept will now be described more fully hereinafter with reference to the accompanying drawings, in which preferred variants of the inventive concept are shown. This inventive concept may, however, be embodied in many different forms and should not be construed as limited to the variants set forth herein; rather, these variants are provided for thoroughness and completeness, and to fully convey the scope of the inventive concept to the skilled person.

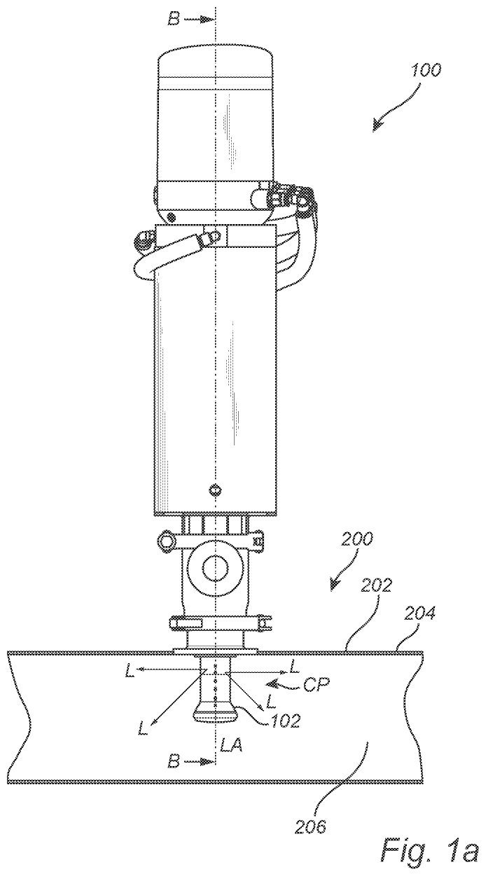

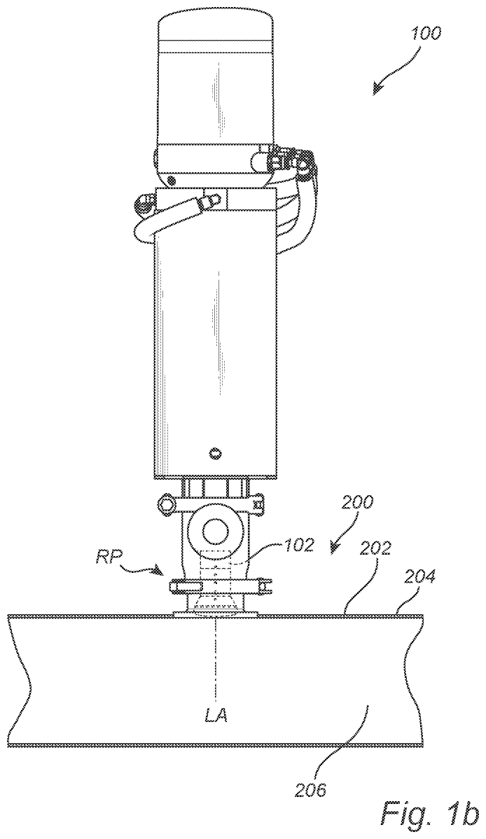

Referring now to the drawings and to FIGS. 1a and 1b in particular, here is conceptually depicted a system 200 including a retractable cleaning apparatus 100 for spray cleaning of pipes 202 or vessels 204. The retractable cleaning apparatus 100 includes a rotatable spray head 102 which is configured to spray the interior 206 of the pipes 202 or vessels 204 with a cleaning liquid L. In FIG. 1a, the retractable cleaning apparatus 100 is depicted in a cleaning position CP in which position the rotatable spray head 102 is moved into and present in the depicted pipe 202. The size, i.e. the diameter of the pipe 202 may vary greatly. The diameter of the pipe 202 may for instance be 150, 300, 500 or 1000 mm to give a few non-limiting examples. It is to be understood that the pipe 202 may be replaced by any type of vessel 204.

In FIG. 1b the retractable cleaning apparatus 100 is depicted in a retracted position RP in which position the rotatable spray head 102 is moved out of the depicted pipe 202. In the retracted position RP, the end portion of the rotatable spray head 102 is the sole part of the retractable cleaning apparatus 100 which is visible from the interior 206 of the depicted pipe 202. The end portion of the rotatable spray head 102 seals the interior 206 of the depicted pipe 202 in a fluid tight manner in the retracted position RP. The rotatable spray head 102 is shown in phantom in the retracted position RP.

Thus, the rotatable spray head 102 is linearly movable between the retracted position RP and the cleaning position CP along the longitudinal axis LA of the rotatable spray head 102.

The rotatable spray head 102 is rotatable about the longitudinal axis LA of the rotatable spray head 102 independent of a flow of the cleaning liquid L. In other words, the rotatable spray head 102 is rotatable by a drive mechanism that does not depend on any flow of the cleaning liquid L. Hence, the rotatable spray head 102 is driven independently of any flow of the cleaning liquid L. In yet other words, the rotatable spray head 102 is rotatable irrespective of if there is a flow of cleaning liquid L or not. Further, the rotatable spray head 102 is rotatable independent of a pressure of the cleaning liquid L. Furthermore, the rotatable spray head 102 is rotatable independent of a flow, such as a mass flow or volume flow, of the cleaning liquid L. The rotatable spray head 102 is also rotatable with an angular velocity that is independent of the flow of the cleaning liquid L.

The rotatable spray head 102 is configured for reciprocating rotation about the longitudinal axis LA of the rotatable spray head 102. Hence, the rotatable spray head 102 is configured to rotate back and forth about the longitudinal axis LA of the rotatable spray head 102. In other words, the rotatable spray head 102 is configured to rotate in a first direction, e.g. clockwise, and then reverse its direction to rotate in a second opposite direction, e.g. counterclockwise, repeatedly such that a reciprocating rotation about the longitudinal axis LA of the rotatable spray head 102 is achieved.

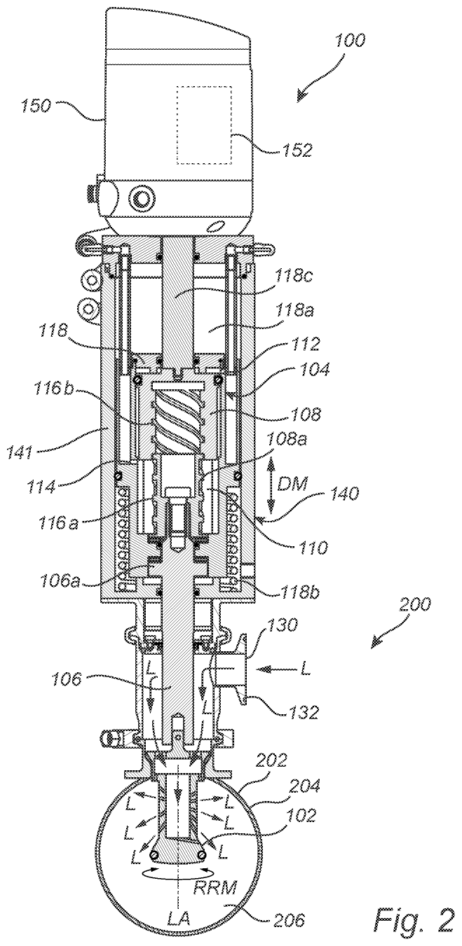

The rotation of the rotatable spray head 102 will be described in detail below with reference to FIG. 2.

In the depicted retractable cleaning apparatus 100 the rotatable spray head 102 is rotatable with an angular velocity within a range of 0.1-1.3 radians per second. This angular velocity corresponds roughly to an instantaneous rotational speed of 0.95-12.4 rpms. The rotatable spray head 102 may be rotatable with other angular velocities.

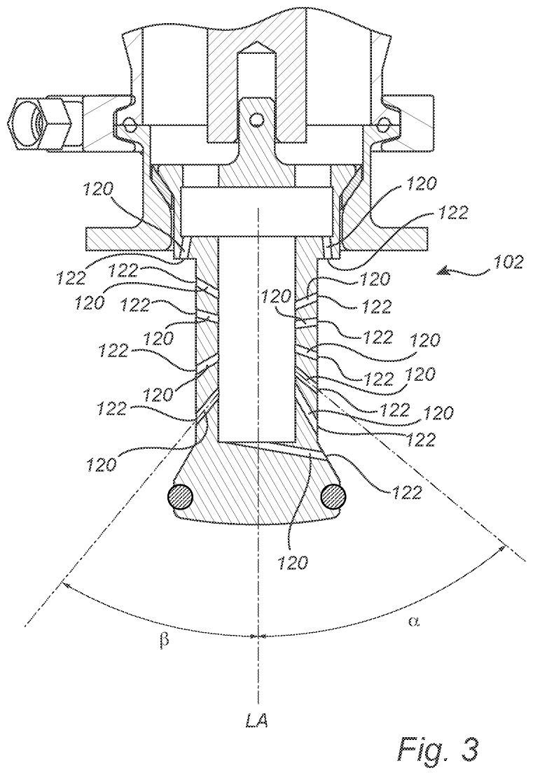

Now referring to FIG. 2, here is conceptually depicted the system 200 including the retractable cleaning apparatus 100 of FIGS. 1a and 1b. In FIG. 2, a cross sectional view of the retractable cleaning apparatus 100 along the line B-B of FIG. 1a is shown. In FIG. 2 the rotatable spray head 102 is in the cleaning position CP. The design of the depicted rotatable spray head 102 is shown in greater detail in FIG. 3 to which reference is also made.

The rotatable spray head 102 of the depicted retractable cleaning apparatus 100 of FIGS. 1a, 1b and 2 is as described linearly movable between a retracted position RP and a cleaning position CP along the longitudinal axis LA of the rotatable spray head 102. The movement between the retracted position RP and a cleaning position CP is achieved by a pneumatically driven linearly movable second piston 118. The linearly movable second piston 118 is mechanically coupled to the rotatable spray head 102 via a pneumatically driven unit 104 which will be described in greater detail below. The depicted linearly movable second piston 118 is operated by introducing pressurized air above the linearly movable second piston 118 in the piston chamber 118a. When pressurized air is introduced above the linearly movable second piston 118 in the piston chamber 118a the linearly movable second piston 118 is pushed downwards in FIG. 2, resulting in that the rotatable spray head 102 is moved to the cleaning position CP. The rotatable spray head 102 is moved to the retracted position RP by evacuating or draining air form the piston chamber 118a, resulting in that the spring 118b pushes the linearly movable second piston 118 upwards in FIG. 2. Hence, in the event of a pressure loss of the pressurized air, the rotatable spray head 102 will be moved to the retracted position RP by the spring 118b.

In the depicted retractable cleaning apparatus 100 the linearly movable second piston 118 is formed of an upper part of the pneumatically driven unit 104. Hence, when the linearly movable second piston 118 is moved, a significant part of the retractable cleaning apparatus 100 including the pneumatically driven unit 104 and the rotatable spray head 102 is moved along the longitudinal axis LA of the rotatable spray head 102. In practice, a majority of the internal parts of the retractable cleaning apparatus 100 located below the linearly movable second piston 118 is moved correspondingly to the linearly movable second piston 118, resulting in the rotatable spray head 102 is linearly movable between the retracted position RP and the cleaning position CP along the longitudinal axis LA of the rotatable spray head 102.

The linearly movable second piston 118 may be hydraulically driven by a pressurized hydraulic fluid such as hydraulic oil.

The position of the rotatable spray head 102 along the longitudinal axis LA of the rotatable spray head 102 is monitored by a sensor located in a control device 150 of the retractable cleaning apparatus 100. Hence, the control device 150 includes the sensor and a control unit 152 in the depicted retractable cleaning apparatus 100. The sensor is connected to the control unit 152. The sensor is configured to sense the position of the member 118c which is moved inside of the control device 150 correspondingly to a movement of the rotatable spray head 102 along the longitudinal axis LA of the rotatable spray head 102. The control unit 152 is configured to control the introduction and removal of pressurized air above the linearly movable second piston 118 in the piston chamber 118a. Hence, the control unit 152 is configured to control the movement of the rotatable spray head 102 along the longitudinal axis LA of the rotatable spray head 102.

In the depicted retractable cleaning apparatus 100 of FIGS. 1a, 1b and 2 the rotatable spray head 102 is made to rotate about the longitudinal axis LA of the rotatable spray head 102 by the pneumatically driven unit 104. The pneumatically driven unit 104 is configured to convert a reciprocatingly translational drive movement DM to a reciprocatingly rotational movement RRM of the rotatable spray head 102. The depicted pneumatically driven unit 104 is driven by pressurized air.

In the depicted retractable cleaning apparatus 100 of FIGS. 1a, 1b and 2 the rotatable spray head 102 is coupled to a rotatable member 106, which when rotated causes the rotatable spray head 102 to rotate correspondingly. Hence the pneumatically or hydraulically driven unit 104 causes the rotatable spray head 102 to rotate reciprocatingly. The pneumatically or hydraulically driven unit 104 includes a linearly movable first piston 108 and is configured to convert a reciprocatingly translational drive movement DM of the linearly movable first piston 108 to a reciprocatingly rotational movement RRM of the rotatable member 106 and the rotatable spray head 102.

In the depicted retractable cleaning apparatus 100 the linearly movable first piston 108 is mechanically coupled to the rotatable member 106 via the intermediate member 108a. The intermediate member 108a is coupled to the rotatable member 106 such that the intermediate member 108a and the rotatable member 106 corotates. The intermediate member 108a and the rotatable member 106 may as an alternative be integrally formed. The rotatable member 106 is held static with respect to the longitudinal axis LA of the rotatable spray head 102 by means of a rotationally symmetric protrusion 106a provided thereon. A bearing or similar may be provided to reduce friction when rotating the rotatable member 106.

The intermediate member 108a coupled to the rotatable member 106 is provided with external threads 116a. The linearly movable first piston 108 is provided with corresponding internal threads 116b. The respective threads 116a, 116b are meshed, resulting in that a reciprocatingly translational drive movement DM of the linearly movable first piston 108 is converted to a reciprocatingly rotational movement RRM of the rotatable member 106 and the rotatable spray head 102.

The rotatable member 106 and the intermediate member 108a may be differently designed and may for instance be formed as a shaft, a cylinder, a hollow member to give a few non-limiting examples.

The linearly movable first piston 108 is arranged in a piston chamber 110. The piston chamber 110 is provided with a first fluid port 112 configured to pass a fluid into or out of the piston chamber 110 on a first side of the linearly movable first piston 108, such that the linearly movable first piston 108 is linearly moved in the piston chamber 110 in response to passing fluid into or out of the piston chamber 110 through the first fluid port 112.

An inner surface of the piston chamber 110 may be provided with a longitudinal protrusion which may engage a corresponding recess provided on the linearly movable first piston 108. By this arrangement, rotation of the linearly movable first piston 108 with respect to the retractable cleaning apparatus 100 may be prevented. The piston chamber 110 may be fixed for preventing rotation with respect to the retractable cleaning apparatus 100.

In the depicted retractable cleaning apparatus of FIG. 2 the first fluid port 112 is provided such that pressurized air may be passed into or out of the piston chamber 110 on an upper side of the linearly movable first piston 108. Hence, if pressurized air is introduced into the piston chamber 110 through the first fluid port 112 the linearly movable first piston 108 will move downwards in FIG. 2, resulting in a rotational movement of the rotatable member 106 and the rotatable spray head 102. Correspondingly, if pressurized air is removed from the piston chamber 110 through the first fluid port 112 the linearly movable first piston 108 may move upwards in FIG. 2, resulting in an opposite rotational movement of the rotatable member 106 and the rotatable spray head 102.

The piston chamber 110 is provided with a second fluid port 114 configured to pass fluid into or out of the piston chamber 110 on a second side of the linearly movable first piston 108, such that the linearly movable first piston 108 is linearly moved in the piston chamber 110 in response to passing fluid into or out of the piston chamber 110 through the second fluid port 114.

In the depicted retractable cleaning apparatus of FIG. 2, the second fluid port 114 is provided such that pressurized air may be passed into or out of the piston chamber 110 on lower side of the linearly movable first piston 108. Hence, if pressurized air is introduced into the piston chamber 110 through the second fluid port 114 the linearly movable first piston 108 will move upwards in FIG. 2, resulting in a rotational movement of the rotatable member 106 and the rotatable spray head 102. Correspondingly, if pressurized air is removed from the piston chamber 110 through the second fluid port 114 the linearly movable first piston 108 may move downwards in FIG. 2, resulting in an opposite rotational movement of the rotatable member 106 and the rotatable spray head 102.

In the depicted retractable cleaning apparatus of FIG. 2 the linearly movable first piston 108 is caused to move reciprocatingly by alternatingly introducing and removing pressurized air through the first fluid port 112 and the second fluid port 114. In other words, either side of the linearly movable first piston 108 is alternatingly pressurized. The introduction and removal of pressurized air is controlled by means of valves which are controlled by the control unit 152. The rotation speed of the rotatable spray head 102 may consequently be controlled by controlling the speed by which pressurized air is introduced and removed through the first fluid port 112 and the second fluid port 114.

In case of a single fluid port, i.e. the first fluid port 112 or the second fluid port 114, the linearly movable first piston 108 may be spring loaded such that a spring pushes the linearly movable first piston 108 back upon removal of pressurized air through the single fluid port.

In the depicted retractable cleaning apparatus of FIG. 2, each rotational movement of the reciprocatingly rotational movement RRM is less than 8 radians. The maximum rotational movement of a reciprocating rotational movement is determined by how much the rotatable member 106 is rotated during a full stoke of the linearly movable first piston 108. In order to make small rotational movements at a certain point, the linearly movable first piston 108 may be made to reciprocate up and down at a certain point of its stroke length. The maximum rotational movement of a reciprocating rotational movement may be tailored by tailoring the pitch of the threads 116a, 116b.

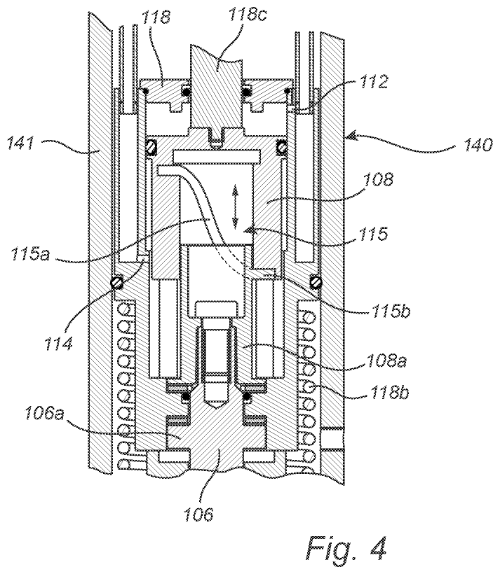

Now also referring to FIG. 4, here is conceptually depicted how the threads 116a, 116b of FIG. 2 have been replaced by a cam arrangement 115. The cam arrangement 115 includes a helical cam groove 115a and a cam protrusion 115b which follows the cam groove 115a. The depicted cam groove 115a is provided on the linearly movable first piston 108. The depicted cam protrusion 115b is provided on the intermediate member 108a. The cam groove 115a may correspondingly be provided on the intermediate member 108a and the cam protrusion 115b on the linearly movable first piston 108. The maximum rotational movement of a reciprocating rotational movement is in this case determined by the pitch of the cam grove 115a, i.e. how much the rotatable member 106 is rotated during a full stoke of the linearly movable first piston 108.

The rotatable spray head 102 may be made to rotate about the longitudinal axis LA of the rotatable spray head 102 by a hydraulically driven unit in a corresponding manner to what has been described above. The hydraulically driven unit may then be driven by a pressurized hydraulic fluid such as hydraulic oil.

The pneumatically or hydraulically driven unit 104 and the pneumatically or hydraulically driven linearly movable second piston 118 are provided together in a common actuator 140. The pneumatically or hydraulically driven unit 104 and the pneumatically or hydraulically driven linearly movable second piston 118 are provided in a common housing 141 of the common actuator 140.

The mechanical parts involved in the linear movement and the rotational movement of the rotatable spray head 102, such as the rotatable member 106, the rotationally symmetric protrusion 106a, the first piston 108, the intermediate member 108a and the piston chamber 110 as well as the second piston 118, the piston chamber 118a and the spring 118b are provided in the actuator 140, more precisely in the housing 141 of the actuator 140. In case of threads 116a, 116b, also the external threads 116a and the internal threads 116b are provided in the actuator 140, more precisely in the housing 141 of the actuator 140. In case of a cam arrangement 115, also the cam arrangement 115, the cam groove 115a and the cam protrusion 115b are provided in the actuator 140, more precisely in the housing 141 of the actuator 140. Further, the first fluid port 112 and the second fluid port 114 are provided in or on the actuator 140, more precisely in or on the housing 141 of the actuator 140.

The rotatable spray head 102 is rotatable about the longitudinal axis LA of the rotatable spray head 102 independent of the rotatable spray head 102 being linearly movable between the retracted position RP and the cleaning position CP along the longitudinal axis LA of the rotatable spray head 102. This is understood from the above. In particular, the rotational movement of the rotatable spray head 102 about the longitudinal axis LA is achieved by means of the driven unit 104 by introducing pressurized air alternatingly on the first and second side of the first piston 108, while the linear movement of the rotatable spray head 102 between the retracted position RP and a cleaning position CP is achieved by means of the pneumatically driven linearly movable second piston 118 by introducing and evacuating pressurized air into and from the piston chamber 118a above the linearly movable second piston 118.

As can be seen in FIG. 2 and in particular in FIG. 3, the rotatable spray head 102 of the depicted retractable cleaning apparatus 100 is provided with a plurality of nozzle channels 120. Each nozzle channel terminating in a nozzle orifice 122. The depicted nozzle channels 120 are formed as bores in the rotatable spray head 102. Each nozzle orifice 122 typically has a diameter within a range of 1-3 mm. Other diameters may be used in order to tailor the spray behavior of the retractable cleaning apparatus 100. For instance, 0.5-5 mm may be used. The nozzle orifices 122 may have other shapes than circular. The nozzle orifices 122 may be elongated, square shaped, star shaped, Z-shaped to give a few non-limiting examples.

In the depicted retractable cleaning apparatus 100 all nozzle channels 120 are extending in a radial direction of the rotatable spray head 102. This means that all nozzle channels 120 are extending in a direction coinciding with an arbitrary radial plane of the longitudinal axis LA of the rotatable spray head 102. By this arrangement, no rotational reactional force is exhibited on the rotatable spray head 102 by a flow of cleaning liquid L through the nozzle channels 120.

Not all nozzle channels 120 need to extend in a radial direction of the rotatable spray head 102. However, preferably, a majority of the nozzle channels 120 are to extend in a radial direction of the rotatable spray head 102. In fact, no nozzle channel 120 need to extend in a radial direction of the rotatable spray head 102. In other words, some or all nozzle channels 120 may be inclined with respect to any radial plane of the longitudinal axis LA of the rotatable spray head 102.

As can be seen in FIG. 3, the nozzle channels 120 extend with different angles α, ß with respect to the longitudinal axis LA of the rotatable spray head 102. The fact that the nozzle channels 120 extend with different α, ß angles with respect to the longitudinal axis LA of the rotatable spray head 102 brings about that an efficient spray cleaning pattern with a desirable coverage of the interior 206 of the pipes 202 or vessel 204 at hand may be achieved. In other words, a plurality of spray jets sprayed at different angles and forming a spray pattern may be achieved.

Preferably, at least two of the nozzle channels 120 may extend at different angles α, ß with respect to the longitudinal axis LA of the rotatable spray head 102. However, all nozzle channels 120 may extend at the same angle with respect to the longitudinal axis LA of the rotatable spray head 102.

The depicted rotatable spray head 102 of FIG. 3 is provided with 12 nozzle channels 120, each terminating in a nozzle orifice 122. The nozzle channels 120 are arranged along two lines of the rotatable spray head 102. The lines being opposite to each other and parallel to the longitudinal axis LA of the rotatable spray head 102. Preferably, the rotatable spray head 102 is provided with 4-40 nozzle channels 120, more preferred 4-30 nozzle channels 120, further preferred 10-30 nozzle channels 120, even more preferred 20-25 nozzle channels 120, each terminating in a nozzle orifice 122. Alternatively, the rotatable spray head 102 is provided with 4-20 nozzle channels 120, such as with 10-14 nozzle channels 120, each terminating in a nozzle orifice 122.

When the retractable cleaning apparatus 100 is used for spray cleaning of pipes 202 or vessels 204, a first measure is typically to move the rotatable spray head 102 from the retracted position RP to the cleaning position CP along a longitudinal axis LA of the rotatable spray head 102. Followingly, the rotatable spray head 102 is made to rotate reciprocatingly as have been described above. At the same time, prior to or consecutive to, a cleaning liquid L is introduced through the opening 130 of flange 132. The cleaning liquid L is then following the path indicated with arrows marked L in FIG. 2 before it exists the rotatable spray head 102 through the nozzle channels 120, thereby providing a spray pattern including a plurality of spray jets L as schematically indicated in FIG. 2. The cleaning liquid L is typically provided at a pressure in a range of 2-8 bars.

When the spray cleaning of the pipes 202 or vessels 204 is finished, the flow of the cleaning liquid L is turned off, i.e. cleaning liquid L is no longer introduced through the opening 130 of flange 132. When turning off the flow of the cleaning liquid L, a spray pattern is no longer provided by the rotatable spray head 102. At the same time, prior to or consecutive to, turning off the cleaning liquid L, the reciprocatingly rotational movement RRM of the spray head is turned off by stopping the reciprocatingly translational drive movement DM of the linearly movable first piston 108. The rotatable spray head 102 is then moved from the cleaning position CP to the retracted position RP along the longitudinal axis LA of the rotatable spray head 102, such that the end portion of the rotatable spray head 102 is the sole part of the retractable cleaning apparatus 100 that is visible from the interior 206 of the pipes 202 or vessels 204. Hence, the end portion of the rotatable spray head 102 is generally flush with the walls of the pipes 202 or vessels 204. In other words, the rotatable spray head 102 is no longer projecting into the interior 206 of the pipes 202 or vessels 204.

Even though the inventive concept has been described with reference to specific exemplifying variants thereof, many different alterations, modifications and the like will become apparent for those skilled in the art. Variations to the disclosed variants may be understood and effected by the skilled addressee in practicing the claimed invention, from a study of the drawings, the disclosure, and the appended claims. Furthermore, in the claims, the words “comprising” and “including” does not exclude other elements or steps, and the indefinite article “a” or “an” does not exclude a plurality.

1. A retractable cleaning apparatus for spray cleaning of pipes or vessels, the retractable cleaning apparatus comprising:
a rotatable spray head configured to spray the interior of the pipes or vessels with a cleaning liquid, wherein the rotatable spray head being linearly movable between a retracted position and a cleaning position along a longitudinal axis of the rotatable spray head,
the rotatable spray head being rotatable about the longitudinal axis of the rotatable spray head independent of a flow of the cleaning liquid, and the rotatable spray head being rotatable with an angular velocity that is independent of the flow of the cleaning liquid.

2. The retractable cleaning apparatus according to claim 1, wherein the rotatable spray head is rotatable with an angular velocity within a range of 0.1-1.3 radians per second.

3. The retractable cleaning apparatus according to claim 1, wherein the rotatable spray head is rotatable about the longitudinal axis of the rotatable spray head independent of the rotatable spray head being linearly movable between the retracted position and the cleaning position along the longitudinal axis of the rotatable spray head.

4. The retractable cleaning apparatus according to claim 1, wherein the rotatable spray head is configured for reciprocating rotation about the longitudinal axis of the rotatable spray head.

5. The retractable cleaning apparatus according to claim 4, further comprising:
a pneumatically or hydraulically driven unit, wherein the pneumatically or hydraulically driven unit is configured to convert a reciprocatingly translational drive movement to a reciprocatingly rotational movement of the rotatable spray head.

6. The retractable cleaning apparatus according to claim 5, wherein the rotatable spray head is coupled to a rotatable member, and wherein the pneumatically or hydraulically driven unit including a linearly movable first piston, the pneumatically or hydraulically driven unit being configured to convert a reciprocatingly translational drive movement of the linearly movable first piston to a reciprocatingly rotational movement of the rotatable member.

7. The retractable cleaning apparatus according to claim 6, wherein the linearly movable first piston is arranged in a piston chamber, the piston chamber including a first fluid port configured to pass a fluid into or out of the piston chamber on a first side of the linearly movable first piston, such that the linearly movable first piston is linearly moved in the piston chamber in response to passing fluid into or out of the piston chamber through the first fluid port.

8. The retractable cleaning apparatus according to claim 7, wherein the piston chamber including a second fluid port configured to pass fluid into or out of the piston chamber on a second side of the linearly movable first piston, such that the linearly movable first piston is linearly moved in the piston chamber in response to passing fluid into or out of the piston chamber through the second fluid port.

9. The retractable cleaning apparatus according to claim 6, wherein the rotatable member is mechanically coupled to the linearly movable first piston.

10. The retractable cleaning apparatus according to claim 9, wherein the rotatable member is mechanically coupled to the linearly movable first piston by means of a cam arrangement or by means of threads.

11. The retractable cleaning apparatus according to claim 1, the retractable cleaning apparatus further comprising:
a pneumatically or hydraulically driven linearly movable second piston mechanically coupled to the rotatable spray head, the linearly movable second piston being configured to linearly move the rotatable spray head between the retracted position and the cleaning position.

12. The retractable cleaning apparatus according to claim 11, wherein the pneumatically or hydraulically driven unit and the pneumatically or hydraulically driven linearly movable second piston are provided in a common actuator.

13. The retractable cleaning apparatus according to claim 5, wherein each rotational movement of the reciprocatingly rotational movement is less than 8 radians.

14. The retractable cleaning apparatus according to claim 1, wherein the rotatable spray head includes a plurality of nozzle channels each terminating in a nozzle orifice, wherein a majority of the nozzle channels extending in a radial direction of the rotatable spray head.

15. The retractable cleaning apparatus according to claim 1, wherein the rotatable spray head includes a plurality of nozzle channels each terminating in a nozzle orifice, wherein at least two of the nozzle channels extend at different angles with respect to the longitudinal axis of the rotatable spray head.

16. The retractable cleaning apparatus according to claim 1, wherein the rotatable spray head includes 4-40 nozzle channels, each terminating in a nozzle orifice.

17. The retractable cleaning apparatus according to claim 14, wherein each nozzle orifice has a diameter within a range of 0.5-5 mm.

18. System comprising:
a pipe or a vessel,
a retractable cleaning apparatus according to claim 1,
wherein the retractable cleaning apparatus is attached to the pipe or vessel and is configured to spray an interior surface of the pipe or vessel with the cleaning liquid.
